(19) United States
(12) Patent Application Publication
(10) Pub. No.: US 2015/0199033 A1
(43) Pub. Date: Jul. 16, 2015

(54) METHOD FOR SIMULATING A GRAPHICS TABLET BASED ON PEN SHADOW CUES

(71) Applicant: National Taiwan University of Science and Technology, Taipei City (TW)

(72) Inventors: Chin-Shyurng Fahn, Taipei City (TW); Bo-Yuan Su, Taipei City (TW)

(21) Appl. No.: 14/296,212

(22) Filed: Jun. 4, 2014

(30) Foreign Application Priority Data
Jan. 13, 2014 (TW) 103101123

(51) Int. Cl. G06F 3/0346; G06F 3/03; G06T 7/00

(52) U.S. Cl. CPC G06F 3/0346; G06T 7/0042; G06F 3/0304; G06T 2207/10016

(57) ABSTRACT

The present invention discloses a method for simulating a graphics tablet based on pen shadow cues, the method applying to execution in a computer for simulating a graphics tablet and comprising the steps of: capturing an image; identifying a tablet from the image according to a predetermined tablet recognition procedure; identifying a pen entering the tablet according to a predetermined pen recognition procedure; and detecting a pen shadow of the pen according to a predetermined pen shadow recognition procedure and determining the relationship of contact and separation between the pen and the pen shadow for simulating the graphics tablet. Since the present invention can use a single webcam to simulate the graphics tablet, the drawbacks including inconvenience, heaviness, vulnerability and high cost of conventional graphics tablets can be overcome by the present invention.

### PRIORITY CLAIM

This application claims the benefit of the filing date of Taiwan Patent Application No. 103101123, filed Jan. 13, 2014, entitled “A METHOD FOR SIMULATING A GRAPHICS TABLET BASED ON PEN SHADOW CUES,” and the contents of which is hereby incorporated by reference in its entirety.

### FIELD OF THE INVENTION

The invention discloses a method for simulating a graphics tablet, more particularly, the invention relates to a method for simulating a graphics tablet based on pen shadow cues, the method applying to execution in a computer for simulating a graphics tablet

### BACKGROUND OF THE INVENTION

Conventional graphics tablets are a common input device for computers, which is usually composed of a dedicated pen and a tablet. Users draw with the pen in a specific region of the tablet to do writing, as well as emulating mouse functions. As for functions, take handwriting tablets produced by WACOM for example. When the pen (stylus) is moving above the tablet, the movement of the mouse cursor is controlled. When the pen tip touches the tablet, left click button of the mouse is signaled to the computer. In addition, there is a button attached to the pen (stylus), by pressing the button, the right click of the mouse is signaled. In addition to mouse function emulation, the pen (stylus) is equipped with pen tilt angle and pressure detection. The thickness and depth of strokes in handwriting can be rendered with corresponding software.

Besides the previously mentioned, the conventional graphics tablet is an electronic device. However, it is sophisticated in structure and complex in design, and thus usually has the following disadvantages: (1) Overweight: The conventional graphics tablet is made up of complex electronic circuits, with the expansion of the drawing areas and increase the functions, the weight will increase, making carrying a burden for users. (2) Increase in space: The conventional graphics tablet generally does not support folding functions. Therefore, increasing the drawing area causes the volume of the tablets body to be larger. As a result, a larger tablet requires more space when storing and carrying. (3) High cost: With the increasing performance and upgrades, the conventional graphics tablet constantly increases in price. Take WACOM's handwriting tablet for example, the price is above NTD 5,000. Models with larger sizes are above NTD 10,000. (4) Vulnerability to breaking: Since the conventional graphics tablet is an electronic device, there is always a risk that it may be damaged if bumped or pressed too hard, and must be handled with care. (5) Poor practicality: The actual sensing area of a handwriting tablet is much smaller than its body size, which means space is wasted.

According to the above description of a conventional graphics table, due to its internal electronic structure, it has the drawbacks including being overweight, taking too much space, high cost, vulnerability to breaking, and poor practicality, so improvements must be made in order to solve the disadvantages of the conventional graphics tablet.

### SUMMARY OF THE INVENTION

The present invention provides a method for simulating a graphics tablet based on pen shadow cues, the method applying to execution in a computer for simulating a graphics tablet. The present invention uses computer vision technology to emulate the graphics tablet, capturing any quadrilateral planes and detecting the pen-like object within the FOV of a single webcam to be emulated both as a graphics tablet and a stylus pen (the pen used for the graphics tablet). The present invention can only use the single webcam to emulate the function of the graphics tablet, which can efficiently reduce the cost disadvantages conventional graphics tablets may have.

In order to achieve the above purposes, the invention provides a method for simulating a graphics tablet based on pen shadow cues, the method applying to execution in a computer for simulating a graphics tablet and comprising the steps of: capturing an image; identifying a tablet from the image according to a predetermined tablet recognition procedure; identifying a pen entering the tablet according to a predetermined pen recognition procedure; and detecting a pen shadow of the pen according to a predetermined pen shadow recognition procedure and determining the relationship of contact and separation between the pen and the pen shadow for simulating the graphics tablet, wherein the image is captured by a webcam.

The predetermined tablet recognition procedure used in the present invention comprises the following sub-steps of: turning the color space of RGB (Red/Green/Blue, RGB) into the color space of HSV (Hue/Saturation/Value, HSV), and performing a multi-valued segmentation; capturing a colored area of the tablet selected by a user; acquiring four points from the four corners of the pixel area, the pixel area being a quadrilateral shaped and the color thereof is the best approximation in the plurality of colored area of the tablet; confirming whether the quadrilateral area can be the tablet or not; and recording and storing the tablet information.

The predetermined pen recognition procedure used in the present invention comprises the following sub-steps of: clearing the area of the tablet, the shadow and the user's hand; capturing all of the recorded and stored colored area; finding the area in accordance with a characteristic of the pen; calculating a tilt angle, a pen tip coordinate, and a user's writing hand with a left hand mode or right hand mode for the pen; and recording and storing the pen information.

The predetermined pen shadow recognition procedure used in the present invention comprises the following sub-steps of: clearing the area of the tablet, the pen and the user's hand; capturing a pen tip surrounding the shadow of the pen; capturing a pen shadow of the pen; and determining the relationship of contact and separation between the pen and the pen shadow.

Compared to conventional techniques, the present invention provides a method for simulating a graphics tablet based on pen shadow cues, the method applying to execution in a computer for simulating a graphics tablet. The invention mainly uses the single webcam and detects three objects separately to emulate the function of the graphics tablet, the quadrilateral plane as the tablet, the pen-like object which comprises the shape with a long shaft as the pen, and the shadow of the pen-like object as the pen shadow. The present invention can detect the variations of the pen shadow, and the moving direction of the object at the same time, which can make it possible to detect if a pen has touched a tablet with a single camera to simulate an expensive graphics tablet with complex function. Due to the present invention's use of only a single webcam to emulate the function of the graphics tablet, the present invention can efficiently reduce the cost, and solve the disadvantages traditional graphics tablets may have, such as not being easy to carry, heavy, fragile, and any other disadvantage.

The advantage and spirit of the invention may be understood by the following recitations together with the appended drawings.

### BRIEF DESCRIPTION OF THE DRAWINGS

FIG. 1 is a flow chart illustrating a method for simulating a graphics tablet based on pen shadow cues according to an embodiment of the invention.

FIG. 2 is a flow chart illustrating a predetermined tablet recognition procedure according to an embodiment of the invention.

FIG. 3 is a flow chart illustrating a predetermined pen recognition procedure according to an embodiment of the invention.

FIG. 4 is a flow chart illustrating a predetermined pen shadow recognition procedure according to an embodiment of the invention.

FIG. 5 is a schematic diagram illustrating an image performing a multi-level segmentation according to an embodiment of the invention.

FIG. 6 is a schematic diagram illustrating a method for grouping neighboring pixels in the tablet recognition procedure according to an embodiment of the invention.

FIG. 7 is a schematic diagram illustrating the acquisition of the four points of the pixel area in the tablet recognition procedure according to an embodiment of the invention.

FIG. 8 is a schematic diagram illustrating a method of neighboring pixel groups in the pen recognition procedure according to an embodiment of the invention.

FIG. 9 is a schematic diagram illustrating the method for detecting the pen tilt angle in the pen recognition procedure according to an embodiment of the invention.

FIG. 10 is a schematic diagram illustrating the method for detecting the pen tip in the pen recognition procedure according to an embodiment of the invention.

FIG. 11 is a schematic diagram illustrating the preemptive detection region for improving the detection speed in the pen recognition procedure according to an embodiment of the invention.

FIG. 12 is a schematic diagram illustrating the pen and the pen shadow in the pen shadow recognition procedure according to an embodiment of the invention.

FIG. 13 is a schematic diagram illustrating a method of neighboring pixels group in the pen shadow recognition procedure according to an embodiment of the invention.

FIG. 14 is a schematic diagram illustrating the computation method for the distance between the pen and pen shadow in the pen shadow recognition procedure according to an embodiment of the invention.

### DETAILED DESCRIPTION

In order for the purpose, characteristics and advantages of the present invention to be more clearly and easily understood, the embodiments and appended drawings thereof are discussed in the following.

The present invention is concerning a method for simulating a graphics tablet based on pen shadow cues. More specifically, by using a single webcam to detect and recognize three objects and the method used to achieve the function. The webcam detects three objects separately, which is the quadrilateral plane as the tablet, the pen-like object which comprises the shape with a long shaft as the pen, and the shadow of the pen-like object as the pen shadow.

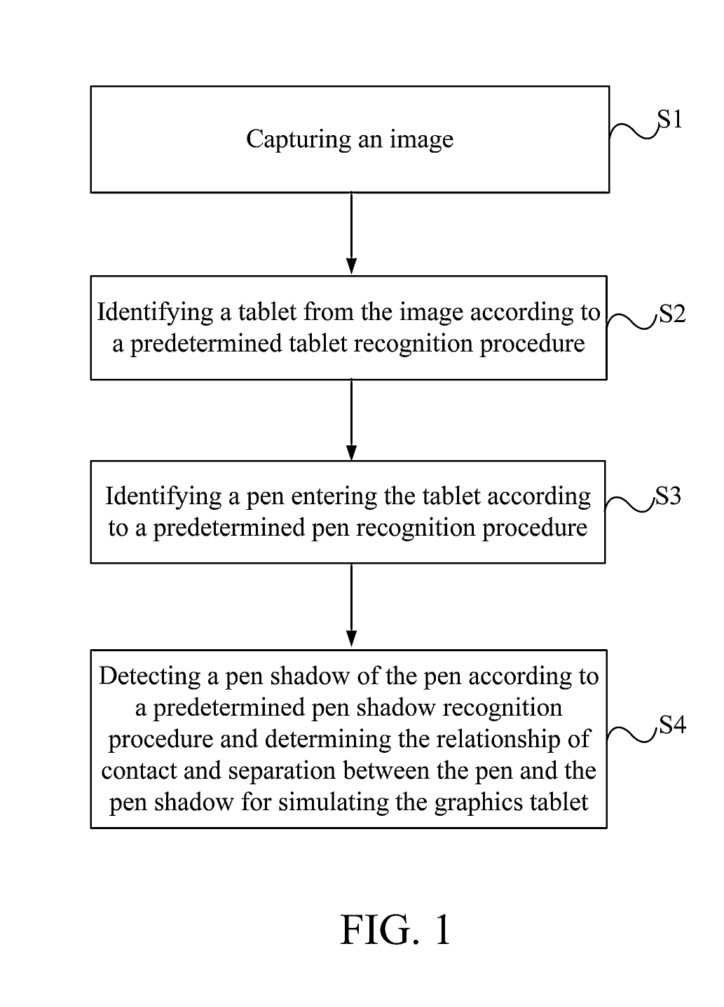

FIG. 1 is a flow chart illustrating a method for simulating a graphics tablet based on pen shadow cues according to an embodiment of the invention. According to an embodiment, the present invention provides a method for simulating a graphics tablet based on pen shadow cues, the method applying to execution in a computer for simulating a graphics tablet and comprising the steps of: (S1) capturing an image; (S2) identifying a tablet from the image according to a predetermined tablet recognition procedure; (S3) identifying a pen entering the tablet according to a predetermined pen recognition procedure; and (S4) detecting a pen shadow of the pen according to a predetermined pen shadow recognition procedure and determining the relationship of contact and separation between the pen and the pen shadow for simulating the graphics tablet.

The present invention is applying to execution in a computer for simulating a graphics tablet, wherein the computer can be a personal computer, a notebook computer, a tablet computer, a smart handheld device or any other type of computer. Firstly, in the present embodiment, the step (S1) of the method of the invention is capturing an image, where the image is captured by the webcam. However, the present invention is not limited to the above method. In practical application, the webcam may also be equipped with a built-in digital camera (such as a notebook computer, PDA, etc.).

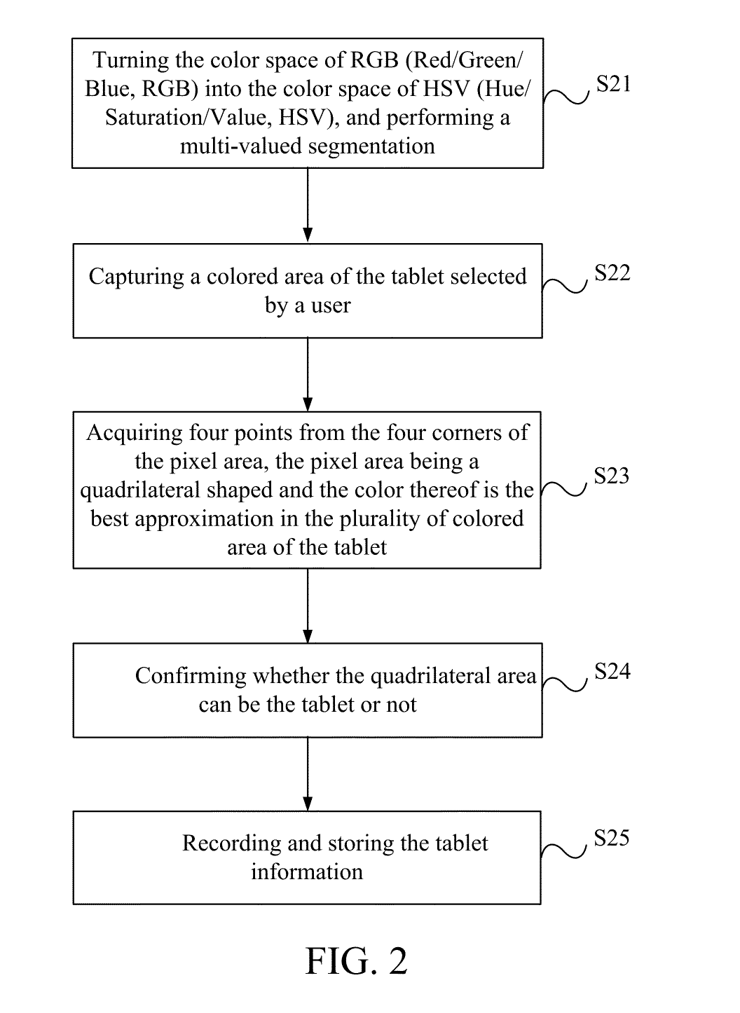

FIG. 2 is a flow chart illustrating a predetermined tablet recognition procedure according to an embodiment of the invention. The step (S2) of the method is for identifying a tablet from the image according to a predetermined tablet recognition procedure. Before detecting the tablet, there are several characteristics defined for the detection of the tablet: (a) quadrilateral shape; (b) tablet surface; (c) color similarity; (d) ratio between tablet and screen. For the above definition, identifying an object corresponds to the conditions according to a predetermined tablet recognition procedure. According to an embodiment, the predetermined tablet recognition procedure of the step (S2) comprises the following sub-steps of: (S21) turning the color space of RGB (Red, Green and Blue) into the color space of HSV (Hue, Saturation, Value), and performing a multi-level segmentation; (S22) capturing a colored area of the tablet selected by a user; (S23) acquiring four points from the four corners of the pixel area, the pixel area being a quadrilateral shaped and the color thereof is the best approximation in the plurality of colored area of the tablet; (S24) confirming whether the quadrilateral area can be the tablet or not; and (S25) recording and storing the tablet information.

Firstly, in the sub-step (S21) is turning the color space of RGB (Red/Green/Blue, RGB) into the color space of HSV (Hue/Saturation/Value, HSV), and performing a multi-level segmentation. This is done because the HSV color space representation is more similar to human's color perception. Usually, the colors of the objects are similar, so we use multi-level segmentation to group areas of similar colors together to better identify objects in an image.

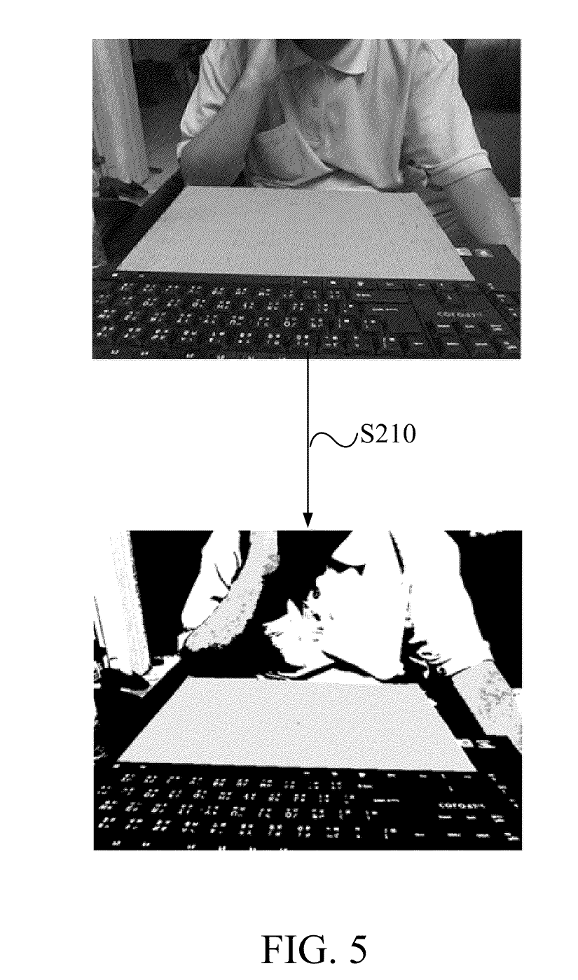

FIG. 5 is a schematic diagram illustrating an image performing a multi-level segmentation according to an embodiment of the invention. In the HSV color space, the H is hue, which represents different kinds of colors. The embodiment of the invention uses multi-level segmentation to group the colors. With different degrees of precision, the invention can choose to segment an image into three colors (red, green, and blue), six colors (red, green, blue, purple, cyan, and yellow), or twelve colors (red, green, blue, purple, cyan, cyan-blue, yellow, purple-blue. and so on). The other S and V channels represent the saturation and intensity of the pixels. An adaptive binarization is applied to the segmentation of these channels. The threshold for segmentation is the average value of the image for the S and V channel respectively. Finally, FIG. 5 shows the image changed after the multi-level segmentation.

The sub-step (S22) includes capturing a colored area of the tablet selected by a user. When a user has selected an area in the image to represent the tablet, the pixel value processed by multi-level segmentation is recorded. Then, the invention searches for all neighboring pixels with the same value in the image, wherein the search direction is from left to right and from top to bottom. When a pixel with the same value is found, the invention detects if the left of the current pixel point p(x,y), the left pixel point p(x−1,y), and the top of the current pixel point p(x,y), the top pixel point p(x,y−1), both of them are classified. Because this approach is from left to right and from top to bottom, only the left pixel point and the top pixel point need to be detected. When the pixel point represents the color of the tablet, the pixel point will instantly be classified, so there aren't the pixel been missed for classify.

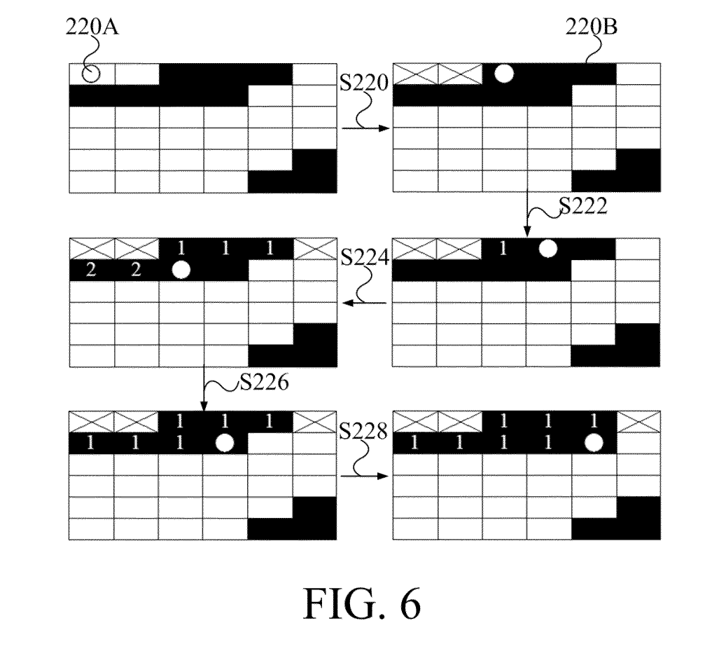

FIG. 6 is a schematic diagram illustrating a method for grouping neighboring pixels in the tablet recognition procedure according to an embodiment of the invention. The present invention adopts the method for grouping neighboring pixels of the tablet recognition procedure to aim for a first searching address 220A and a first pixel point 220B, wherein the first searching address 220A is the current searching address for a pixel, and the first pixel point 220B is the pixel with the same color in the image to act as the tablet. Firstly, (S220) searches from left to right and from top to bottom. Furthermore, (S222) due to the left pixel and top pixel not being labeled, the first searching address 220A is given a new label. Moreover, (S224) due to only the left pixel being labeled, giving the first searching address 220A the same label. Furthermore, (S226) due to the left pixel and the top pixel have different labels, migrating the two labels and giving the first searching address 220A the label. Finally, (S228) due to the left pixel and top pixel having been classified with the same label, giving the first searching address 220A the same label.

Through the method of grouping neighboring pixels of the tablet recognition procedure, all the pixels with the same color as the tablet will be found, and given the same label for its neighboring pixels, while the different colored areas will be given a different label. The results of the label are then saved into a list to boost performance of the following searches for the address of the object clicked on by the user.

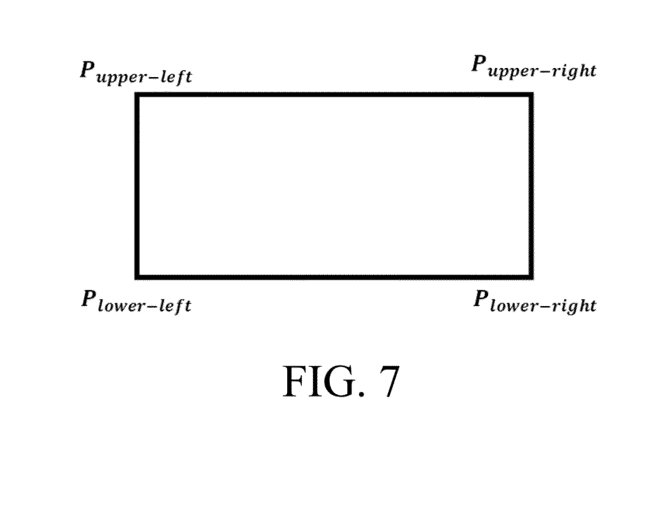

FIG. 7 is a schematic diagram illustrating the acquisition of the four points of the pixel area in the tablet recognition procedure according to an embodiment of the invention. In the sub-step (S23) for acquiring four points from the four corners of the pixel area, the pixel area being a quadrilateral shaped and the color thereof is the best approximation in the plurality of colored area of the tablet, the object can be chosen by the user from the photographic image to obtain all the pixel addresses within the object's area. Then, the pixels can be formed into a maximum object quadrilateral. Let Objectpixels be set to all the pixel addresses in the object area, p_i (x,y) is the pixel of Objectpixels, where i is the index of pixels in Objectpixels, i=1,2, n, and x and y are the coordinates in the image. The formula for finding the four corner points Pupper-left, Pupper-right, Plower-right, and Plower-left composing the maximum object quadrilateral is shown as the following Eq.

P_{upper-left}=p(x,y)

with min{x+y|pᵢ(x,y)∈ Objectₚᵢₓₑₗₛ, i=1,2, . . . , n}

P_{upper-right}=p(x,y)

with max{x−y|pᵢ(x,y)∈ Objectₚᵢₓₑₗₛ, i=1,2, . . . , n}

P_{lower-right}=p(x,y)

with max{x+y|pᵢ(x,y)∈ Objectₚᵢₓₑₗₛ, i=1,2, . . . , n}

P_{lower-left}=p(x,y)

with min{x−y|pᵢ(x,y)∈ Objectₚᵢₓₑₗₛ, i=1,2, . . . , n}

Besides, the sub-step (S24) confirms whether the quadrilateral can be the tablet or not. After the four corner points of the quadrilateral are acquired, the sub-step further confirms if the selected quadrilateral meets the defined characteristics of the tablet. If it does, go to the next step; otherwise, return a message to user.

Finally, the sub-step (S25) records and stores the tablet information, saves the tablet address, coordinates of each pixel, and the original color information of the tablet or any other information of the tablet into memory to be used for pen detection in later steps.

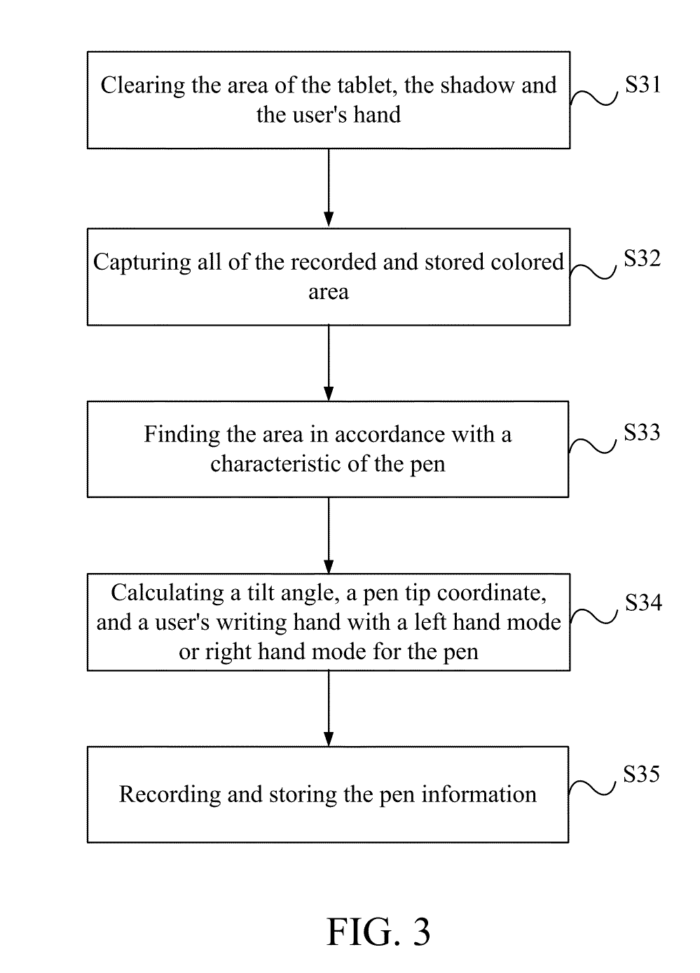

FIG. 3 is a flow chart illustrating a predetermined pen recognition procedure according to an embodiment of the invention. Step (S3) is for identifying a pen entering the tablet according to a predetermined pen recognition procedure. Before the pen detection, some pen characteristics are defined: (a) an object shape with a long shaft; (b) a height/width ratio of more than two; (c) a tilt angle that is less than 80° when in use. According to an embodiment, the predetermined pen recognition procedure of step (S3) comprises the following sub-steps of: (S31) clearing the area of the tablet, the shadow and the user's hand; (S32) capturing all of the recorded and stored colored area; (S33) finding the area in accordance with a characteristic of the pen; (S34) calculating an inclination angle, a pen tip coordinate, and a user's writing hand with a left hand mode or right hand mode for the pen; and (S35) recording and storing the pen information.

Firstly, in sub-step (S31) for clearing the area of the tablet, the shadow and the user's hand, recording and storing the pen information (pixel addresses and their colors), and the frame for recognizing which way the user holds the pen in the FOV (field of view), the foreground can be obtained by computing the color difference under the HSV color space. Let P_{now}(x,y) be the pixels of the frame which a user holds the pen into FOV, and P_{tablet}(x,y) be the pixels of frame which the tablet is detected. Compute the absolute value of the difference of pixels of these two frames to obtain the pixels P_{dest}(x,y) of the new frame and is shown as the following Eq.

P_{dest}(x,y)=|P_{now}(x,y)−P_{tablet}(x,y)|

The tablet area is cleared by the above Eq. by computing the difference to obtain an image for clearing the tablet. Then, the shadows are removed by erasing the pixels with lower H values. Therefore, only the pen and the user's hand which holds the pen will remain. Furthermore, removing the areas with colors similar to the hand, so the remaining image will be the pen and the user's sleeve, and further performing a binarization to get the image cleared of the shadow and the user's hand. Finally, save the remaining areas into a list to be used for later use.

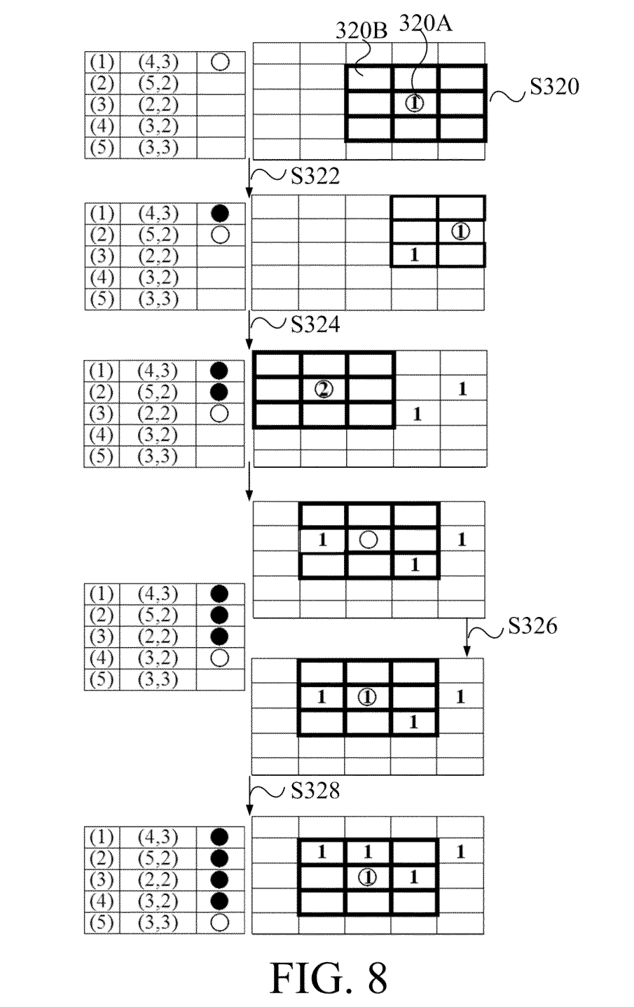

FIG. 8 is a schematic diagram illustrating a method of neighboring pixel groups in the pen recognition procedure according to an embodiment of the invention. All the pixels at p(x,y) are read in the list sequentially, then the eight neighboring pixels p(x−1,y−1), p(x,y−1), p(x+1,y−1), p(x−1,y), p(x+1,y), p(x−1,y+1), p(x,y+1), and, p(x+1,y+1) are inspected, wherein the processing procedure comprises a second searching address 320A and eight neighboring pixels 320B, where the second searching address 320A is the current searching address for the pixel. First, (S320) due to the eight neighboring pixels 320B of the second searching address 320A not being classified, the second searching address 320A is given a new label. Furthermore, (S322) due to the eight neighboring pixels 320B of the second searching address 320A, only one pixel is classified, where the second searching address 320A is given the same label. Moreover, (S324) due to the eight neighboring pixels 320B of the second searching address 320A not being classified, the second searching address 320A is given a new label. Besides, (S326) due to the eight neighboring pixels 320B of the second searching address 320A, more than one neighboring pixels are classified. If they have more than one label, label them with the first classified label and label the second searching address 320A to the same label. Finally, (S328) due to the eight neighboring pixels 320B of the second searching address 320A, there is more than one neighboring pixel classified, and if all of them are the same label, label the second searching address 320A to the same label. This approach is also applicable for the condition for when the list sequence is different from the pixel value sequences. When the entire list is read, all the pixels will have been classified.

Moreover, the sub-step (S33) is for finding the area in accordance with a characteristic of the pen. After obtaining all the groups of pixels and finding the minimum quadrilateral area, an approximate quadrilateral area will be defined as the bounding box for the pen area. Let Areapixels be the set of pixels in the area, where Pi(x,y) is the pixel of Areapixels, i is the index of pixels in the area, (i=1,2, n), x and y are the coordinates in the image, and \hat{p}_{upper-left}, \hat{p}_{upper-right}, \hat{p}_{lower-right}, and \hat{p}_{lower-left} form the bounding box, are obtained by the following Eq.

\hat{p}_{upper-left}=p(x, y)

with min{x|pᵢ(x,y)∈ Areaₚᵢₓₑₗₛ, i=1,2, . . . , n}

and min{y|pᵢ(x,y)∈ Areaₚᵢₓₑₗₛ, i=1,2, . . . , n}

\hat{p}_{upper-right}=p(x, y)

with max{x|pᵢ(x, y)∈ Areaₚᵢₓₑₗₛ, i=1,2, . . . , n}

and min{y|pᵢ(x, y)∈ Areaₚᵢₓₑₗₛ, i=1,2, . . . , n}

\hat{p}_{lower-right}=p(x, y)

with max{x|pᵢ(x, y)∈ Areaₚᵢₓₑₗₛ, i=1,2, . . . , n}

and max{y|pᵢ(x, y)∈ Areaₚᵢₓₑₗₛ, i=1,2, . . . , n}

\hat{p}_{lower-left}=p(x y)

with min{x|pᵢ(x, y)∈ Areaₚᵢₓₑₗₛ, i=1,2, . . . , n}

and max{y|pᵢ(x, y)∈ Areaₚᵢₓₑₗₛ, i=1,2, . . . , n}

The present invention adopted the method for the defining the minimum quadrilateral area which acts as the bounding box for the pen area by rotating all pixels in the area from 0 to 90 degree iteratively. In each of the iterations, the bounding-box is obtained from the above Eq. until the smallest bounding box is found. After the smallest bounding-box is obtained, it is rotated back to its original angle, then the complete smallest bounding-box which covers the pen is obtained.

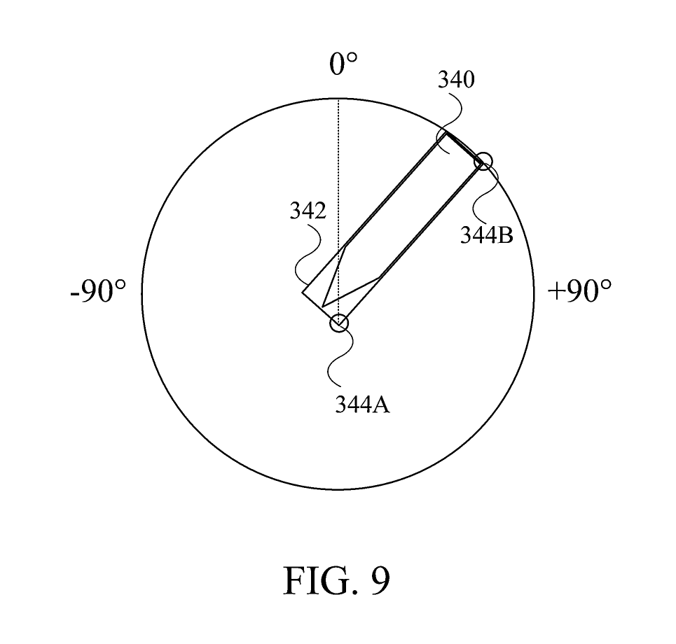

FIG. 9 is a schematic diagram illustrating the method for detecting the pen tilt angle in the pen recognition procedure according to an embodiment of the invention. The sub-step (S34) is for calculating a tilt angle, a pen tip coordinate, and a user's writing hand with a left hand mode or right hand mode for the pen. First, computing the tilt angle of the pen, and according to the pen producing the minimum quadrilateral area 342 which acts as the bounding box for the pen area 340, and then getting two points from the left side or the right side of the minimum quadrilateral area 342. Use the lower extreme point 344A as the original point of the quadrilateral coordinate system to compute the angle of the upper point B. The angle calculated is the tilt of the pen.

In the method for computing the tilt angle of the pen, first use the two parameter arc tangent functions shown as the following Eq.

$$atan 2 ( y , x ) = \{ \begin{matrix}arctan ( \frac{y}{x} ) & x > 0 \\ arctan ( \frac{y}{x} ) + π & y \geq 0 , x < 0 \\ arctan ( \frac{y}{x} ) - π & y < 0 , x < 0 \\ + \frac{π}{2} & y > 0 , x = 0 \\ - \frac{π}{2} & y < 0 , x = 0 \\ undefined & y = 0 , x = 0\end{matrix}$$

Then, using A as the center to rotate B 90 degrees is shown as the following Eq.

$$[ \begin{matrix}{L}_{x} \\ {L}_{y}\end{matrix} ] = [ \begin{matrix}+ cos 90 ° & - sin 90 ° \\ + sin 90 ° & + cos 90 °\end{matrix} ] [ \begin{matrix}{B}_{x} - {A}_{x} \\ {B}_{y} - {A}_{y}\end{matrix} ]$$

Then, computing the pen tilt angle, θ_{tilt angle}, between A and B is shown as the following Eq.

$${θ}_{tilt angle} = \frac{atan 2 ( {L}_{y} , {L}_{x} )}{π} \times 180 °$$

Finally, once all the groups of pixels are obtained, search through all the groups and find if any of them have the characteristics of a pen, and decide the location of the pen. If two or more groups correspond to the condition, choose the one closer to the bottom of the image. This is because the object below the pen is usually a tablet, and other objects might not exist.

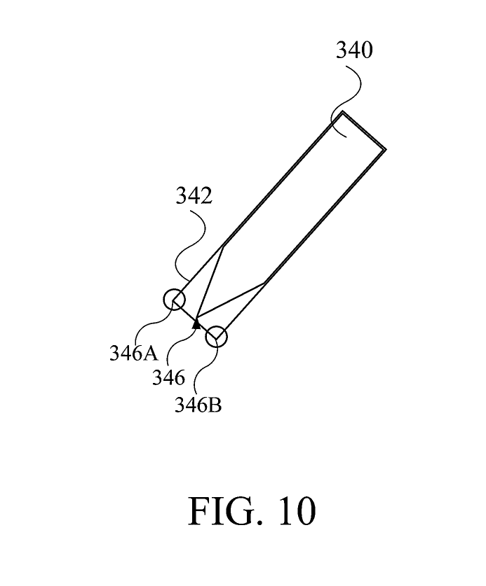

FIG. 10 is a schematic diagram illustrating the method for detecting the pen tip in the pen recognition procedure according to an embodiment of the invention. Usually when users are writing with a pen, the pen tips 346 are at the bottom. Therefore, the invention uses the center point of the bottom edge of the bounding-box as the pen tips 346. Furthermore, choosing the first corner point 346A and the second corner point 346B at the bottom of the bounding-box as the point A and the point B, and getting the center of Nib as the pen tips 346, is shown by the following Eq.

Nibₓ=(Bₓ−Aₓ)×0.5+Aₓ

Nib_{y}=(B_{y}−A_{y})×0.5+A_{y}

Moreover, after obtaining the pen tip (Nib) 346, use it as the middle line and get the brightness from the left side and the right side of the frames processed by the difference computation. The brighter side is the side which the user holds the pen. When the user has changed the holding hand, the result is updated, and computing the brightness of the left side and the right side are shown as the following Eq.

$${Left}_{Brightness} = {\sum }_{x = 0}^{{Nib}_{x} - 1} {\sum }_{y = 0}^{m} {f ( x , y )}_{Brightness}$$

$${Right}_{Brightness} = {\sum }_{x = {Nib}_{x + 1}}^{n} {\sum }_{y = 0}^{m} {f ( x , y )}_{Brightness}$$

$$Hand = \{ \begin{matrix}Left , & if {Left}_{Brightness} > {Right}_{Brightness} \\ Right , & if {Left}_{Brightness} \leq {Right}_{Brightness}\end{matrix}$$

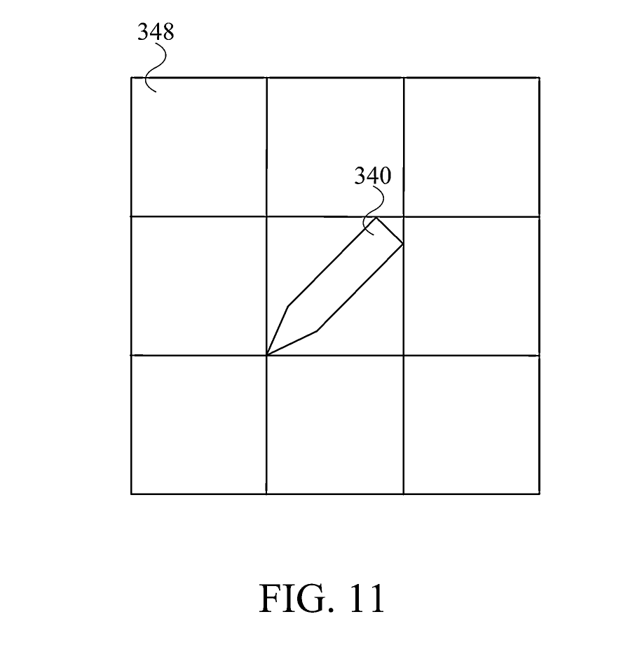

FIG. 11 is a schematic diagram illustrating the preemptive detection region for improving the detection speed in the pen recognition procedure according to an embodiment of the invention. In order to improve the detection speed in the next frames, the preemptive detection region detects the pen 340 from the neighboring pixels of the last detected pen 340. Set a first area 348 of the bounding box for the pen 340 as the preemptive detection region for the next frames, wherein the first area 348 of the bounding box for the pen 340 is composed of a 3×3 region. This is because the pen movement is continuous, so the address of the pen usually posits in the neighboring area. If the pen is not found in the preemptive detection region, extend the region. Extending the region consists of extending the width and height of the last detected pen each time. The extension stops when all the pixels in the image are within the region.

Finally, in the sub-step (S35) for recording and storing the pen information, saving the information of the pen comprises an object shape with a long shaft, a height/width ratio greater than two, a tilt angle less than 80 degrees or any other characteristic of the pen used for pen shadow detection.

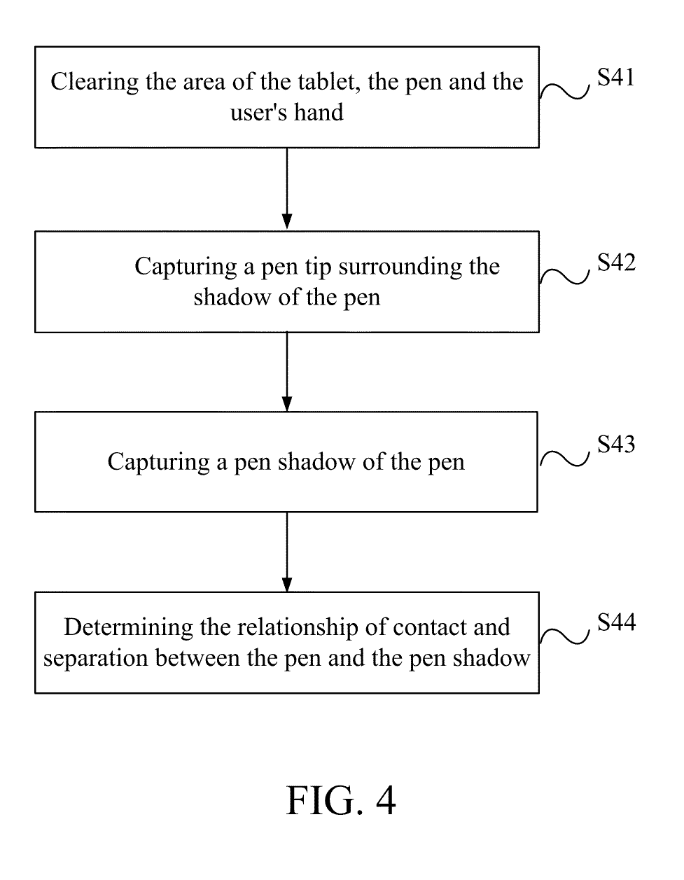

FIG. 4 is a flow chart illustrating a predetermined pen shadow recognition procedure according to an embodiment of the invention. Step (S4) of the method of the invention consists of detecting a pen shadow of the pen according to a predetermined pen shadow recognition procedure and determining the relationship of contact and separation between the pen and the pen shadow for simulating the graphics tablet. The shadow detection is for deciding whether the pen has touched the tablet by observing the relation when the pen does not touch the tablet, and finding the following conditions: First, when the pen has touched the tablet, the shadow of the pen must be touching the pen tip; moreover, there is a time interval for the pen and the pen shadow merging process before the pen has touched the tablet.

With both observations, the present invention provides a predetermined pen shadow recognition procedure to detect the relation between the pen and the tablet, as illustrated in FIG. 4. According to an embodiment, the predetermined pen shadow recognition procedure of the step (S4) comprises the following sub-steps of: (S41) clearing the area of the tablet, the pen and the user's hand; (S42) capturing a pen tip surrounding the shadow of the pen; (S43) capturing a pen shadow of the pen; and (S44) determining the relationship of contact and separation between the pen and the pen shadow.

First, (S41) clearing the area of the tablet, the pen and the user's hand, by recording and storing the pen information (pixel addresses and their colors), and the frames which the user holds the pen into the FOV (field of view), a image for clearing the tablet can be acquired by computing the color difference under the HSV color space. Then, erasing the areas belongs to the pen according to the information from pen detection. The remaining area below the pen will be the shadow.

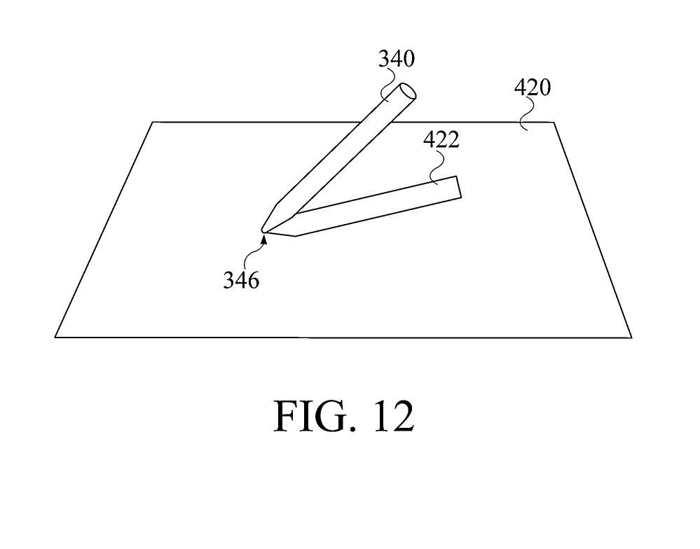

FIG. 12 is a schematic diagram illustrating the pen and the pen shadow in the pen shadow recognition procedure according to an embodiment of the invention. Furthermore, the sub-step (S42) is for capturing a pen tip surrounding the shadow of the pen. Because the pen shadow 422 is formed by the pen 340 itself, when the pen 340 has touched the tablet 420, the pen shadow 422 of the pen 340 will touch the pen tip 346.

The purpose of the pen shadow 422 detection is for deciding whether the pen 340 has touched the tablet 420. Therefore, the only thing that needs to be known is if there is a pen shadow 422 close to the pen tip 346, and the shape of the shadow. Use Nib for pen tip 346 detection as the center, and compute the area within radius r, and get the x and y coordinates within the area as shown in the following Eq.

$$[ \begin{matrix}x \\ y\end{matrix} ] = [ \begin{matrix}sin θ & {Nib}_{x} \\ cos θ & {Nib}_{y}\end{matrix} ] [ \begin{matrix}r \\ 1\end{matrix} ]$$

Because the shadow does not occlude the pen itself, the pen detected must be erased first. Assuming that the pixels in are equivalent to the pixels by the following Eq, where i has the same sequence of the sequences of pixels, and form the pixels into a pixel set Q. E is subtracted from Q to get p, where E is the pixels of a pen, as shown by the following Eq.

qᵢ=p(xᵢ, yᵢ), i=1,2,3, . . . n

Q={q₁, q₂, . . . qₙ}

Q−E={p|p ∈ Q, p ∉ E}

Then, get the maximum brightness and minimum brightness of the set p, in order to adjust the contrast of the set. The pixels with brightness larger than 50% of the pixels are regarded as shadows. Set bᵢ as the brightness of the pixels within the set p, i=1,2, . . . n, and B is the set of bᵢ, as shown by the following Eq.

$$B = \{ {b}_{1} , {b}_{2} , ⋯ {b}_{n} \}$$

$${b}_{i}^{′} = \frac{{b}_{i} - min ( B )}{max ( B ) - min ( B )}$$

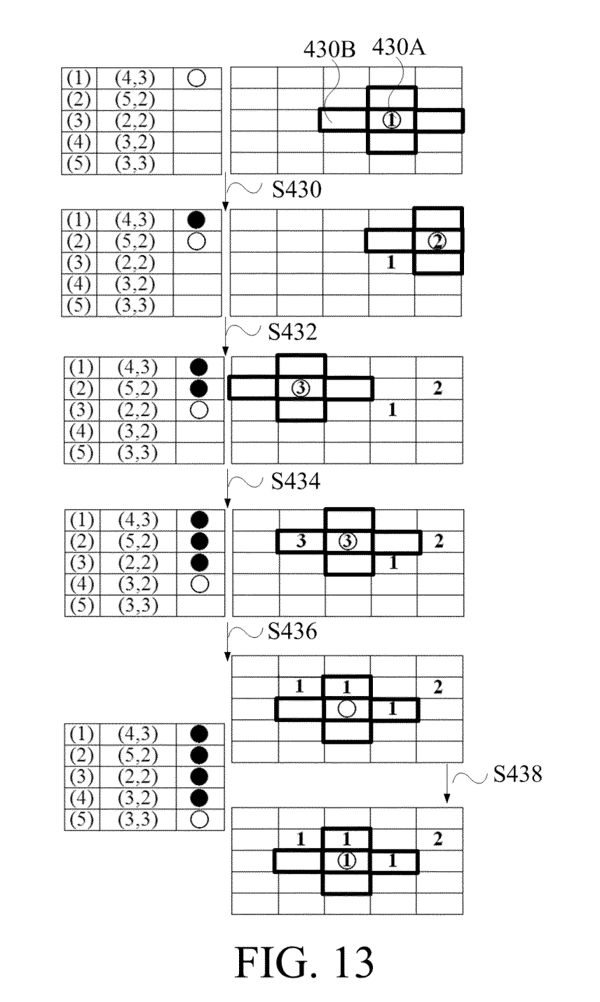

FIG. 13 is a schematic diagram illustrating a method of neighboring pixels group in the pen shadow recognition procedure according to an embodiment of the invention. The sub-step (S43) is for capturing a pen shadow of the pen. Because the obtained shadow is close to the pen tip, the shadow of the pen tip must be the largest shadow area. Therefore, an approach is used to get the largest shadow area close to the pen tip and is improved by only detecting four neighboring pixels p(x−1, y), p(x+1, y), p(x, y−1), and p (x, y+1). The detection area is very small, and the shadow is not a real object, so it is possible that the corners will connect to each other. Therefore, there is a need to make a more strict classification for shadows in the case of obtaining shadows which are not pen tips. The processing procedure is illustrated as shown in FIG. 13, wherein the processing procedure comprises a third searching address 430A and four neighboring pixels 430B, wherein the third searching address 430A is the current searching address for the pixels, and the four neighboring pixels 430B are the four neighboring pixels of the third searching address 430A. First, (S430) due to the four neighboring pixels 430B not being labeled, the third searching address 430A is given a new label. Furthermore, (S432) due to the four neighboring pixels 430B not being labeled, the third searching address 430A is given a new label. Moreover, (S434) due to the four neighboring pixels 430B not being labeled, the third searching address 430A is given a new label. Besides, (S436) due to one of the four neighboring pixels 430B being labeled, the third searching address 430A is labeled with the same label. Finally, (S438) due to two or more of the four neighboring pixels 430B being labeled with different labels, all labels will be migrated and the third searching address 430A will be assigned the migrated label.

After obtaining the pen shadow area, use the method proposed above with the following Eq. to find the bounding-box of the pen shadow in order to get the boundaries and position of the area.

First, obtaining all groups of pixels, then finding the minimum quadrilateral area, this is an approximate quadrilateral area which acts as the bounding box for the pen area. Let Areaₚᵢₓₑₗₛ be the set of pixels in the area, pᵢ(x, y) is the pixel of Areaₚᵢₓₑₗₛ, where i is the index of pixels in area, (i=1,2, . . . n), x and y are the coordinates in image, and the \hat{p}_{upper-left}, \hat{p}_{upper-right}, \hat{p}_{lower-right}, and \hat{p}_{lower-left} which forms the bounding box obtained by the following Eq.

\hat{p}_{upper-left}=p(x, y)

with min{x|pᵢ(x, y)∈ Areaₚᵢₓₑₗₛ, i=1,2, . . . , n}

and min{y|pᵢ(x, y)∈ Areaₚᵢₓₑₗₛ, i=1,2, . . . , n}

\hat{p}_{upper-right}=p(x, y)

with max{x|pᵢ(x, y)∈ Areaₚᵢₓₑₗₛ, i=1,2, . . . , n}

and min{y|pᵢ(x, y)∈ Areaₚᵢₓₑₗₛ, i=1,2, . . . , n}

\hat{p}_{lower-right}=p(x, y)

with max{x|pᵢ(x, y)∈ Areaₚᵢₓₑₗₛ, i=1,2, . . . , n}

and max{y|pᵢ(x, y)∈Areaₚᵢₓₑₗₛ, i=1,2, . . . , n}

\hat{p}_{lower-left}=p(x, y)

with min{x|pᵢ(x, y)∈ Areaₚᵢₓₑₗₛ, i=1,2, . . . , n}

and max{y|pᵢ(x, y)∈ Areaₚᵢₓₑₗₛ, i=1,2, . . . , n}

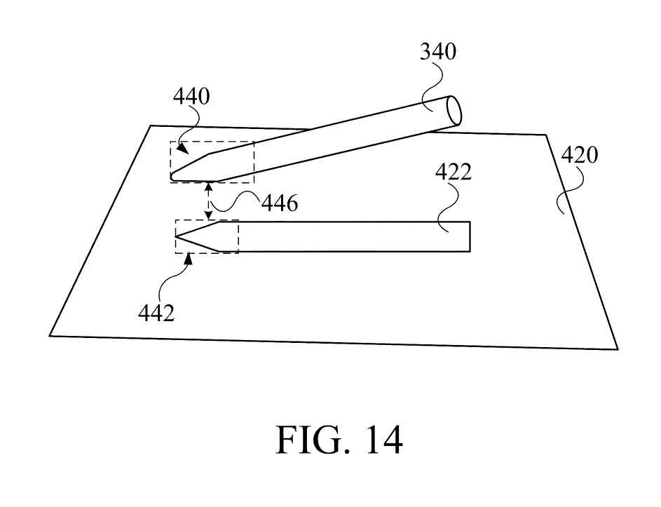

FIG. 14 is a schematic diagram illustrating the computation method for the distance between the pen and pen shadow in the pen shadow recognition procedure according to an embodiment of the invention. Sub-step (S44) is for determining the relationship of contact and separation between the pen and the pen shadow. By analyzing the changing of the pen shadow 422, the computation method can detect the relation between of pen 340 and the tablet 420. When the pen 340 is under different tilt angles and the conditions that the pen contacts and separates the tablet, the computation method can find out that when the pen 340 makes contacts and separates from the tablet 420. There is an interval that the pen 340 makes contacts and separates from the pen shadow 422. This interval can be acquired by capturing consecutive frames and calculating the distance 446 between the pen 340 and the pen's shadow 422 in the respective frames.

The sub-step (S44) is for computing the Eq. of the distance 446 between the pen 340 and the pen shadow 422, wherein i is the index of frames, PB is a first quadrilateral area 440 of the bounding-box for the pen, SB is a second quadrilateral area 442 of the bounding-box for the pen shadow. The distance 446 D(i) is obtained by SBᵢ^{Top} which acts as the upper edge of the bounding-box for the pen shadow, and PBᵢ^{Bottom} which acts as the bounding-box for the pen, and is shown by the following Eq.

D(i)=SBᵢ^{Top}−PBᵢ^{Bottom}

First, set n as the index of the current frame, and D(n) as the distance between the pen and the pen shadow in the current frame. Then, calculating the difference between D (n) and D(n−1), D(n−1) and D(n−2), D(n−2) and D(n−3), and so on. Finally, computing the average of the differences, which is the average distance variation D̅ᵥₐᵣ between the pen and the pen shadow, wherein m is the number of frames needed for computation, and the average distance variation D̅ᵥₐᵣ is shown by the following Eq.

$${\overline{D}}_{var} = \frac{1}{m} {\sum }_{k = 0}^{m - 1} D ( n - k ) - D ( n - k - 1 ) , m \geq 2$$

After getting the average distance variation D̅ᵥₐᵣ, using the value to detect the current action of the pen for user. D̅ᵥₐᵣ is positive when the pen is leaving the tablet, D̅ᵥₐᵣ is negative when the pen is approaching the tablet, wherein T_{adv} is the threshold for detecting the variation, which is used for discarding frames of only minor variation. If the variation is smaller than the threshold, the result would not be updated. Besides, the present invention can detect the action of the pen approaching or leaving the tablet. When the pen shadow detection is set to a very small area, the invention can deem these two actions as touching and separating respectively. This is because when the detection area is very small, the pen needs to be very close to the tablet to be detected and when the pen is very close to the pen shadow, it is very close to the tablet. Therefore, this can be used for the touching and separating detections. The average distance variation D̅ᵥₐᵣ is used to detect the current action of the pen for user and to detect the action of the pen approaching or leaving the tablet, as shown by the following Eq.

$$Pen Action = \{ \begin{matrix}up , & if {\overline{D}}_{var} > {T}_{adv} \\ down , & if {\overline{D}}_{var} < - {T}_{adv}\end{matrix} , {T}_{adv} \geq 0$$

Compared to conventional techniques, the present invention provides a method for simulating a graphics tablet based on pen shadow cues, the method applying to execution in a computer for simulating a graphics tablet, using computer vision technology to emulate the graphics tablet, capturing a quadrilateral plane within the FOV of a single webcam to emulate a tablet, and detecting the pen-like object which comprises the shape of a long shaft to be held by a user to emulate the stylus (the pen for graphics tablet). By detection the variations of the shadow of the object, the present invention can detect if overlapping objects in the FOV have touched each other and can detect the movement direction of the object. At the same time, the present invention can detect if a pen has touched a tablet with a single camera to simulate a graphics tablet of complex function and high cost. The present invention uses a single webcam to emulate the function of a graphics tablet, which can efficiently reduce costs, and solve the disadvantages traditional graphics tablet may have, such as not being easy to carry, heavy, fragile, and any many other disadvantages.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

1. A method for simulating a graphics tablet based on pen shadow cues, the method applying to execution in a computer for simulating a graphics tablet and comprising the steps of:
capturing an image;
identifying a tablet from the image according to a predetermined tablet recognition procedure;
identifying a pen entering the tablet according to a predetermined pen recognition procedure; and
detecting a pen shadow of the pen according to a predetermined pen shadow recognition procedure and determining the relationship of contact and separation between the pen and the pen shadow for simulating the graphics tablet.

2. The method for simulating a graphics tablet based on pen shadow cues of claim 1, wherein the predetermined tablet recognition procedure of the step (S2) comprises the following sub-steps of:
turning the color space of RGB (Red/Green/Blue, RGB) into the color space of HSV (Hue/Saturation/Value, HSV), and performing a multi-valued segmentation;
capturing a colored area of the tablet selected by a user;
acquiring four points from the four corners of the pixel area, the pixel area being a quadrilateral shaped and the color thereof is the best approximation in the plurality of colored area of the tablet;
confirming whether the quadrilateral area can be the tablet or not; and
recording and storing the tablet information.

3. The method for simulating a graphics tablet based on pen shadow cues of claim 2, wherein the tablet information of the sub-step (S25) comprises the tablet address, coordinates of each pixel, and the original color information of the tablet or any other information of the tablet.

4. The method for simulating a graphics tablet based on pen shadow cues of claim 1, wherein the predetermined pen recognition procedure of the step (S3) comprises the following sub-steps of:
clearing the area of the tablet, the shadow and the user's hand;
capturing all of the recorded and stored colored area;
finding the area in accordance with a characteristic of the pen;
calculating a tilt angle, a pen tip coordinate, and a user's writing hand with a left hand mode or right hand mode for the pen; and
recording and storing the pen information.

5. The method for simulating a graphics tablet based on pen shadow cues of claim 4, wherein the characteristic of the pen comprises an object shape with a long shaft, a height/width ratio greater than two, a tilt angle of less than 80 degrees or any other characteristic of the pen used for pen shadow detection.

6. The method for simulating a graphics tablet based on pen shadow cues of claim 4, wherein the pen information of the sub-step (S35) comprises the coordinates of each pixel, the inclination angle, the pen tip coordinate, and the user's writing hand with the left hand mode or right hand mode for the pen.

7. The method for simulating a graphics tablet based on pen shadow cues of claim 1, wherein the predetermined pen shadow recognition procedure of the step (S4) comprises the following sub-steps of:
clearing the area of the tablet, the pen and the user's hand;
capturing a pen tip surrounding the shadow of the pen;
capturing a pen shadow of the pen; and
determining the relationship of contact and separation between the pen and the pen shadow.

8. The method for simulating a graphics tablet based on pen shadow cues of claim 1, wherein the computer can be a personal computer, a notebook computer, a tablet computer, a smart handheld device or any other type of computer.

9. The method for simulating a graphics tablet based on pen shadow cues of claim 1, wherein the computer comprises a webcam, the image is captured by the webcam.
